(19) United States
(12) Patent Application Publication
(10) Pub. No.: US 2026/0357962 A1
(43) Pub. Date: Nov. 12, 2026

(54) LIGHTING DEVICE WITH A FLEXIBLE COVER FILM AND METHOD OF MANUFACTURE

(71) Applicant: HELLA GMBH & CO. KGAA, Lippstadt (DE)

(72) Inventors: Carsten Hohmann, Warstein (DE); Martin Mügge, Geseke (DE)

(21) Appl. No.: 19/667,070

(22) Filed: May 4, 2026

(30) Foreign Application Priority Data
May 7, 2025 (DE) 102025117387.7

(51) Int. Cl. F21S 41/20; F21S 41/29; B60Q 1/04; B60Q 1/30; B60Q 1/44

(52) U.S. Cl. CPC F21S 41/2805; F21S 41/29; B60Q 1/04; B60Q 1/30; B60Q 1/44

(57) ABSTRACT

The invention relates to a lighting device for vehicles having a shell-shaped housing in which a number of optical components are arranged for generating at least one light function with at least one predetermined light distribution. The housing has a base and a wall projecting from the base, the wall having an opening edge that delimits an opening of the housing. A cover plate is firmly connected to the housing in a region of the opening edge. The cover plate is configured as a printable cover film that is connected to the opening edge of the housing in a force-locking manner.

### CROSS-REFERENCE TO RELATED APPLICATIONS

This application claims priority to German Patent Application 10-2025-117-387.7, filed May 7, 2025, the disclosure of which is incorporated by reference.

### FIELD OF THE INVENTION

The invention relates to a lighting device for vehicles with a shell-shaped housing in which a number of optical components are arranged for generating at least one light function with at least one predetermined light distribution, the housing having a base and a wall projecting from the base and having an opening edge which delimits an opening of the housing, and with a cover plate which is firmly connected to the housing in the region of the opening edge. The invention further relates to a method for mounting a lighting device and a method of manufacturing a cover film.

### BACKGROUND OF THE INVENTION

A lighting device for vehicles is known from DE 10-2023-116-226 A1, which has a shell-shaped housing with a number of optical components. An opening of the housing is closed by a transparent cover plate. Within the housing, a flat light guide is provided as an optical component, into which light is coupled on the narrow side. At least one optical film with micro-optical elements and a further light disk are arranged between the flat light guide and the cover plate, each lying flat against the other. The flat contact of the optical film and the light disk with the flat light guide is achieved by means of a housing frame placed on the front side of the housing. The optical film serves as an optical component arranged within the housing for redirecting the emitted light.

A control panel for a vehicle interior is known from EP 3,690,612 B1, which has a substrate and a flexible film applied to the substrate. The flexible film serves as an elastomeric layer of a vehicle interior control panel that can be backlit by means of an integrated light source.

A lighting device for vehicles is known from DE 10-2016-123-203 B4, with a shell-shaped housing in which a plurality of optical components, such as a light source and optical means such as a reflector or light guide, are arranged. The housing has a base and a wall projecting from the base, which forms an opening edge with an edge at a free end. A cover plate is provided for covering the opening edge, which is connected to the opening edge of the housing by laser welding. The cover plate has a light-transparent main section and, at the edge, a light-impermeable, preferably black, masking section. Due to the non-transparent masking section, the weld seam is not visible to an observer from the outside. The manufacturing effort for the cover plate is relatively high if it is produced using a two-component injection molding process. Relatively large tool halves are required. In addition, a relatively high amount of material is required, as the wall thicknesses of such cover plates are in the range of 2 mm to 4 mm. Another disadvantage is that recycling by type or material is relatively complex.

### SUMMARY OF THE INVENTION

It is therefore the object of the present invention to provide a lighting device for vehicles and a method for mounting the lighting device or producing a cover plate, which provides an attractive appearance of the lighting device in a simple and cost-saving manner in terms of manufacturing technology, wherein in particular a long service life of the cover plate is ensured. To achieve this object, the cover plate is designed as a printable cover film which is connected to the opening edge of the housing in a force-locking manner.

According to the invention, the cover plate is designed as a cover film which is connected at the edge to a housing of the lighting device by a force fit. Since the cover film is designed to be printable, it can have transparent or non-transparent graphics or color gradients or an edge-side masking layer and/or a decor and/or an optical microstructure, so that the lighting device has a distinctive, independent appearance by means of the cover film. The cover film is preferably bendable, so that at least one edge of the cover film is deformable and, in the assembly position, is attached to an opening edge of the housing with a force fit. Since the cover film is connected to the housing only by force fit, it is easier to separate the cover film from the housing after the end of the service life of the lighting device. In particular, this can also make the material recyclable.

According to a further development of the invention, the cover film is designed to be at least partially reversibly formable or bendable, so that, in the assembled state, after a force acting on the cover film, the cover film automatically returns to the original assembled state. This flexibility of the cover film enables pedestrian protection to be realized in the event of a collision between the vehicle and a pedestrian, whereby damage to the cover film is avoided if the force applied does not exceed a predefined threshold value. The cover film can therefore flexibly absorb forces without being destroyed at the same time. The advantage of this is that the replacement of headlights or lights as a lighting device can be avoided. This goes hand in hand with saving resources, materials and costs.

According to a further development of the invention, the cover film has a wall thickness equal to or less than 1 mm. This creates the desired flexibility or resilience so that, on the one hand, undesirable forces can be absorbed in the event of a collision and, on the other hand, a force-fit connection at one edge of the cover film is facilitated. Because the cover film is bendable, it can simply be clamped at its edge.

According to a further development of the invention, the cover film is connected to the housing by screwing or clamping. The advantage of this is that a simple mechanical and long-term stable connection can be created.

According to a further development of the invention, the opening edge of the housing has a fastening flange projecting laterally from a wall of the housing, against which an edge of the cover film rests. The flat contact creates an airtight connection between the housing and the cover film.

According to a further development of the invention, the edge of the cover film is arranged between the fastening flange and an attachment frame of the housing in a clamping and/or circumferentially sealing manner. The edge of the cover film is thus clamped between two fastening surfaces, with clamping forces acting essentially perpendicular to the extension of the edge of the cover film. The advantage of this is that a secure and long-term stable fastening can be created.

According to a further development of the invention, the edge of the cover film is arranged between a fastening flange of the housing and an attachment frame in a clamping and/or circumferentially sealing manner. This ensures a flat and preferably sealed arrangement so that the interior of the housing is airtight to the surroundings.

According to a further development of the invention, the fastening flange of the housing and/or the attachment frame has bulges and/or indentations on a side facing the edge of the cover film, so that the edge of the cover film is arranged deformed transversely to its plane of extension in a mounting position. This can result in deformation and/or forced guidance of the edge of the cover film when it is connected to the housing or attachment frame when the cover film is mounted on the housing.

According to a further development of the invention, an additional clamping element is provided, by means of which the force-locking mounting position of the edge of the cover film on the housing is ensured. In particular, the clamping element encloses a free edge of the edge of the cover film and the fastening flange so that dust deposits are avoided.

According to a further development of the invention, the clamping element is U-shaped in cross-section, so that it embraces free ends of the fastening flange of the housing, the edge of the cover film and, if necessary, an outer edge of the attachment frame.

To solve this object, the invention provides a mounting method. Advantageously, in a first process step, the cover plate is brought into an assembly position in which one edge of the cover film is brought into full-surface contact with a fastening flange of the housing and, if applicable, an attachment frame. In the second step, a force-fit connection is made between the fastening flange of the housing and the edge of the cover film to ensure a firm and long-term stable connection. If the force-fit connection is a screw connection, the cover film is preferably detachably connected to the housing, which simplifies recyclability.

To solve this object, the invention provides a method of manufacture. Advantageously, a color and/or a structure and/or a decor and/or an optical microstructure can be printed on the cover film in a flat state thereof. The printed cover film can then be formed in a thermoforming tool using heat and/or pressure, whereby a main section is essentially flat. If the cover film has not been fed to the forming tool in the form of sheets, but on a roll, the respective cover films are then separated from each other sequentially by a separating tool. Advantageously, this can be used to produce cover films that may have an optical and/or graphic structure or a glare section.

### DESCRIPTION OF THE DRAWINGS

Exemplary embodiments of the invention are explained in more detail below with reference to the drawings. In the drawings:

FIG. 1 is a front view of a lighting device with a cover film covering an opening of a housing of the lighting device;

FIG. 2 is a cross-section through the lighting device in an edge area, the cover film being firmly connected to a fastening flange of the housing by means of a clamp-like clamping element;

FIG. 3 is a cross-section through the lighting device in the edge area, wherein the cover film is firmly connected to a fastening flange of the housing by means of the clamp-like clamping element, wherein the edge of the cover film is clamped or braced between the fastening flange of the housing and an attachment frame;

FIG. 4 is a cross-section through the lighting device in the edge region, wherein the edge of the cover film is clamped or braced between the fastening flange of the housing and the attachment frame, wherein the clamping element has bulges arranged offset perpendicularly to an apex thereof on its opposite limbs;

FIG. 5 is a cross-section through the lighting device in the edge region, wherein the edge of the cover film is clamped or braced between the fastening flange of the housing and the attachment frame, wherein the clamping element has bulges arranged offset perpendicularly to the apex thereof on its opposite limbs, wherein between the edge of the cover film on the one hand and the fastening flange of the housing and the attachment frame on the other hand a flat sealing element is arranged offset relative to one another perpendicular to the apex of the clamping element, which is mounted in an indentation of the fastening flange and the attachment frame;

FIG. 6 is a cross-section through the lighting device in the edge region, wherein the edge of the cover film is clamped or braced between the fastening flange of the housing and the attachment frame, wherein the clamping element has bulges arranged offset perpendicularly to the apex of the same on its opposite limbs, wherein between the edge of the cover film on the one hand and the fastening flange of the housing and the attachment frame on the other hand a flat sealing element is arranged offset to one another perpendicular to the apex of the clamping element, which is mounted in an indentation of the fastening flange and the attachment frame; and

FIG. 7 is a cross-section through the lighting device in the edge area, wherein the cover film is firmly connected to a fastening flange of the housing by means of the clamp-like clamping element, wherein the edge of the cover film is clamped or braced between the fastening flange of the housing and the attachment frame, wherein the fastening flange is connected to the attachment frame by means of a screw connection.

### DETAILED DESCRIPTION OF THE CURRENT EMBODIMENTS

A lighting device for vehicles can, for example, be designed as a headlight that is arranged in a front area of a vehicle to generate at least one light function with at least one light distribution. Alternatively, it can also be arranged as a rear light in a rear region of the vehicle.

The lighting device has a shell-shaped housing 1, which has a base (not shown) and a circumferential wall 2 projecting at an angle therefrom. The height of the wall 2 is such that there is preferably space in the housing 1 for a light source (not shown) and optical light shaping means (optical components), such as a reflector and/or a light guide and/or a lens. The optical light shaping means are designed such that they redirect the light generated by the light source according to a predetermined light distribution, for example low beam and/or high beam distribution, so that the light can be emitted from the lighting device in the main direction of radiation H.

To cover an opening of the housing 1, a cover film 3 is provided as a cover plate, which consists of a light-transparent plastic material, in particular a transparent plastic material, for example PMMA. The cover film 3 is made of a crystal-clear material when it is installed in the headlight. Alternatively, the cover film 3 can be colored, for example red, if it is to be used as a rear light to generate tail light or brake light distribution. The cover film 3 preferably has a constant wall thickness W_{A}, which is less than 1 mm. The cover film 3 is designed to be bendable. It is so flexible that when a normal force is applied to the cover film 3 when it is mounted on the housing 1, it deforms and automatically returns to its original state when this force is released. The cover film 3 is therefore reversibly deformable. Its shape can be changed elastically, whereby it is moved back to its original state after the force is released, provided that this does not exceed a predetermined threshold force that causes the cover film 3 to tear.

Alternatively, the cover film 3 can be printed with a color and/or an optical structure to create a predetermined appearance.

For example, the cover film 3 can be printed circumferentially in an edge region thereof with a black color, so that a masking frame is formed on the cover film 3. In particular, this can conceal an opening edge 4 of the housing 1 for an observer from the outside.

The cover film 3 is connected to the opening edge 4 of the housing 1 in a force-locking manner.

According to a first embodiment of the invention as shown in FIG. 2, the cover film 3 is connected in a clamping and/or latching manner to a fastening flange 5 of the housing 1 projecting laterally from the wall 2. For this purpose, one edge 6 of the cover film 3 lies on a front side of the fastening flange 5 in the main radiation direction H of the lighting device. A clamping element 7 grips around the edge 6 of the cover film 3 and the fastening flange 5 of the housing 1, with opposing legs 8, 8' of the clamping element 7 each generating a mutually directed fixing force F. Both the leg 8 resting on the fastening flange 5 and the second leg 8' of the clamping element 7 resting on the edge 6 of the cover film 3 have a bulge 9 on a side facing the fastening flange 5 or edge of the cover film 3, which enables an additional positive fit. In particular, the fastening flange 5 has an indentation 10 on a side facing the edge 6 of the cover film 3, into which a part of the edge 6 of the cover film 3 is pressed by means of the bulge 9 of the leg 8'. Advantageously, this enables an increase in the contact surface and, in particular, a non-planar contact surface between the edge 6 of the cover film 3 and the fastening flange 5, which increases the clamping force.

According to an alternative embodiment of the invention not shown, the clamping element 7 and/or the fastening flange 5 can also be free of such bulges or indentations, so that the edge 6 of the cover film 3 lies flat against the fastening flange 5 and is pressed against the fastening flange 5 by means of the clamping element 7.

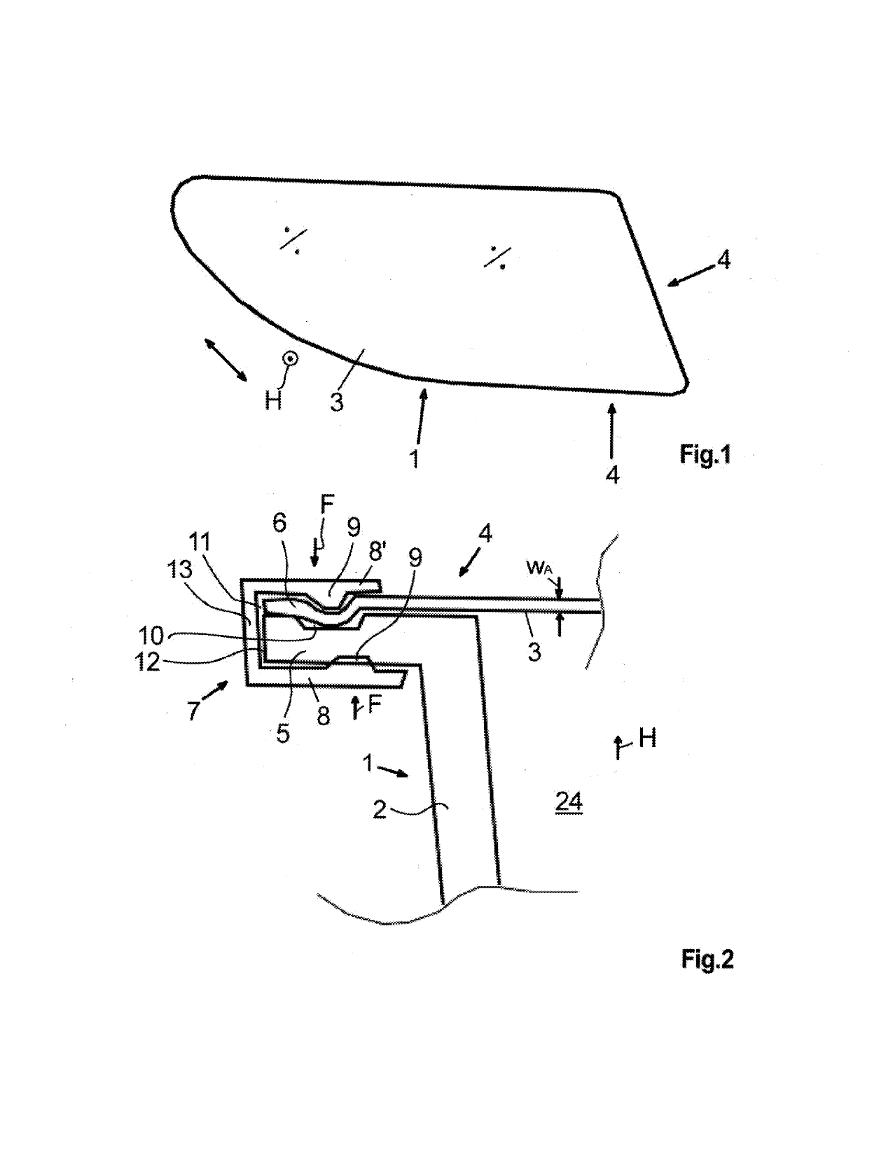

The resulting clamping preferably takes place all the way around the edge 6 of the cover film 3. The edge 6 of the cover film 3 corresponds to the contour of the lighting device or cover film 3 shown in FIG. 1 or the opening edge 4 of the housing 1.

Alternatively, several clamping elements 7, preferably of the same design, can also be arranged at a distance from one another in the circumferential direction of the opening edge 4.

Preferably, free ends or an edge 11 of the cover film 3 and an edge 12 of the fastening flange 5 are in contact with an apex 13 of the clamping element 7. The apex 13 of the clamping element 7 connects the first leg 8 with the second leg 8'.

In this design example, the clamping element 7 has a U-shaped cross-section. Preferably, the apex 13 and the legs 8, 8' are each flat, with the legs 8, 8' rising at a right angle from the apex 13.

The clamping element 7 can be made of a metal or plastic material. The legs 8, 8' form latching elements that can only be moved apart with a predetermined force, so that in the assembly position they exert the latching or clamping force F perpendicular to the extension of the edge 6 of the cover film 3 and the fastening flange 5.

FIG. 1 shows that the cover film 3 completely covers and seals one opening of the housing 1. The airtight closure of the interior 24 of the housing 1 formed in this way is achieved by the force-fit or clamping connection of the edge 6 of the cover film 3 to the fastening flange 5 of the housing 1.

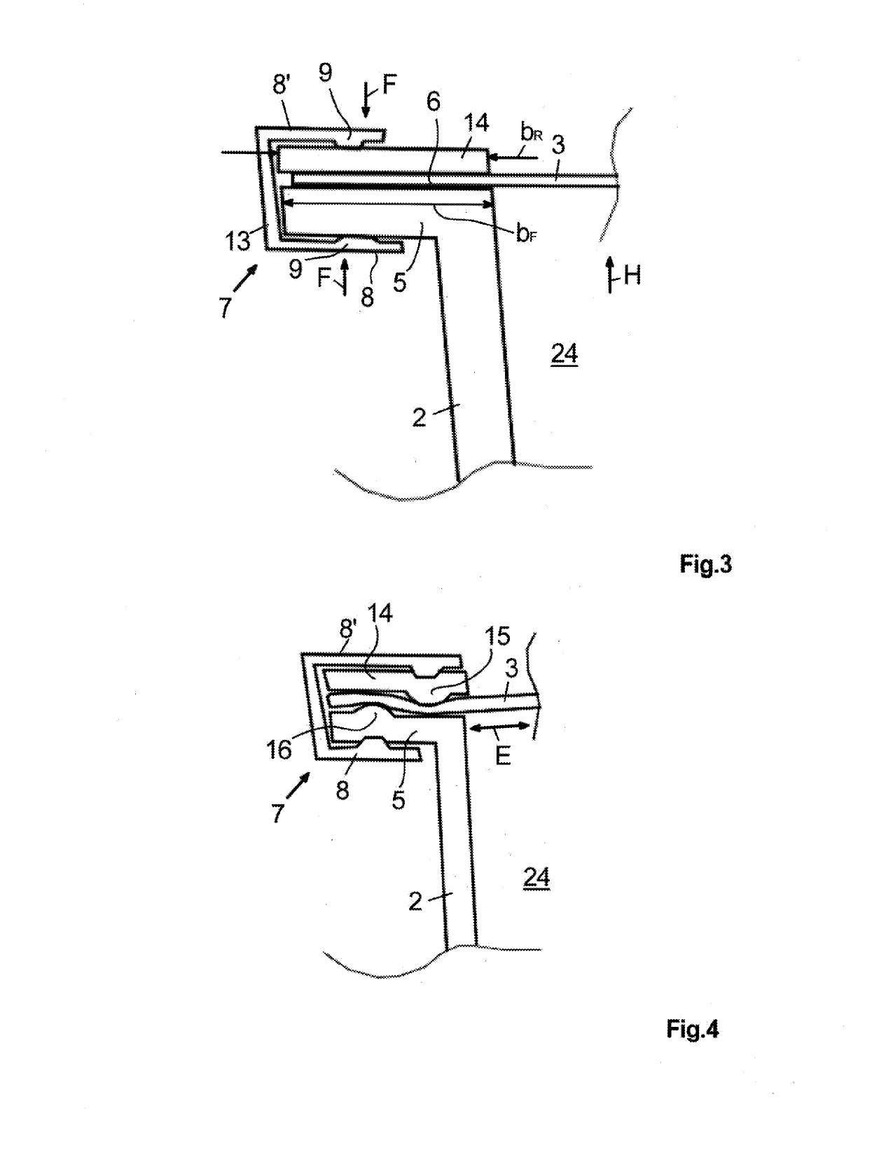

According to a further embodiment of the invention as shown in FIG. 3, in contrast to the first embodiment as shown in FIG. 2, an additional attachment frame 14 is provided, which is inserted into the groove of the clamping element 7 as a separate component.

In the assembly position, the edge 6 of the cover film 3 runs between the attachment frame 14 and the fastening flange 5 of the housing 1.

Identical components or component functions of the different embodiments are given the same reference numbers.

This allows the edge 6 of the cover film 3 to rest flat between the front attachment frame 14 in the main radiation direction H and the fastening flange 5. On a side facing the edge 6 of the cover film 3, the attachment frame 14 and the fastening flange 5 have a flat contact surface. In the present embodiment example, the sides of the attachment frame 14 and the fastening flange 5 facing away from the edge 6 of the cover film 3 are also flat, so that there is no additional form fit between the legs 8 and the fastening flange 5 on the one hand and the further leg 8' and the attachment frame 14 on the other. Instead, the bulges 9 of the legs 8, 8' are flattened in such a way that they lie flat against the sides or surfaces of the attachment frame 14 or the fastening flange 5 facing away from the cover film 3.

According to a further embodiment of the invention as shown in FIG. 4, both the attachment frame 14 and the fastening flange 5 have a bulge 15 or 16 on a side facing the edge 6 of the cover film 3, so that the cover film 3 undergoes deformation at the edge 6 and preferably forced guidance during assembly. In the present embodiment example, the bulge 15 of the attachment frame 14 and the bulge 16 of the fastening flange 5 are arranged offset to one another in a direction perpendicular to the extension of the apex 13 or in the extension direction E of the edge 6 or of the fastening flange 5, so that the edge 6 of the cover film 3 is held in a clamping manner in the assembly position, forming a wave shape.

FIGS. 3 and 4 show that a width b_{R} of the attachment frame 14 corresponds to a width b_{F} of the fastening flange 5. The attachment frame 14 can be designed as a masking frame so that the opening edge 4 of the housing 1 is masked.

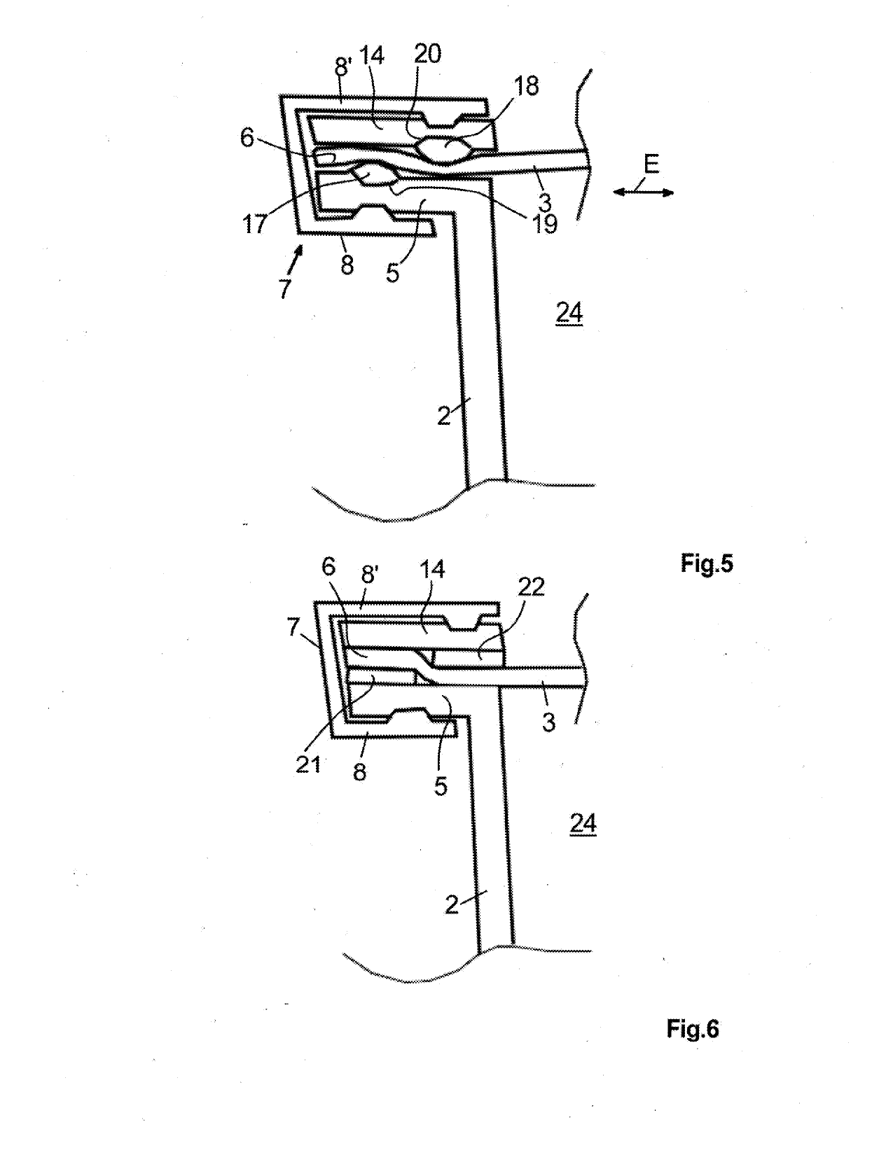

According to a further embodiment of the invention according to FIG. 5, in contrast to the embodiment according to FIG. 4, the undulating mounting position of the edge 6 of the cover film can be brought about by means of a sealing element 17 or 18. A sealing element 17 is arranged on a side of the fastening flange 5 facing the edge 6 of the cover film 3 and a sealing element 18 is arranged on a side of the attachment frame 14 facing the edge 6 of the cover film 3. These two sealing elements 17, 18 are offset in the direction in which the fastening flange 5 or the cover film 3 extends and in a direction perpendicular to the apex 13 of the clamping element 7. The sealing elements 17, 18 can consist of an elastic material, for example a foam material. They can be molded onto the corresponding surfaces of the fastening flange 5 or the attachment frame 14 or inserted as a separate part in an indentation 19 of the fastening flange 5 or indentation 20 of the attachment frame 14. The sealing elements 17, 18 are designed as bulging sealing elements, oval or circular in cross-section, which extend as elongated sealing elements 17, 18 in the circumferential direction of the cover film 3, preferably continuously.

According to an alternative embodiment as shown in FIG. 6, plate-shaped sealing elements 21, 22 can be provided, so that the contact surface between the edge 6 of the cover film 3 and the respective sealing elements 21, 22 is increased.

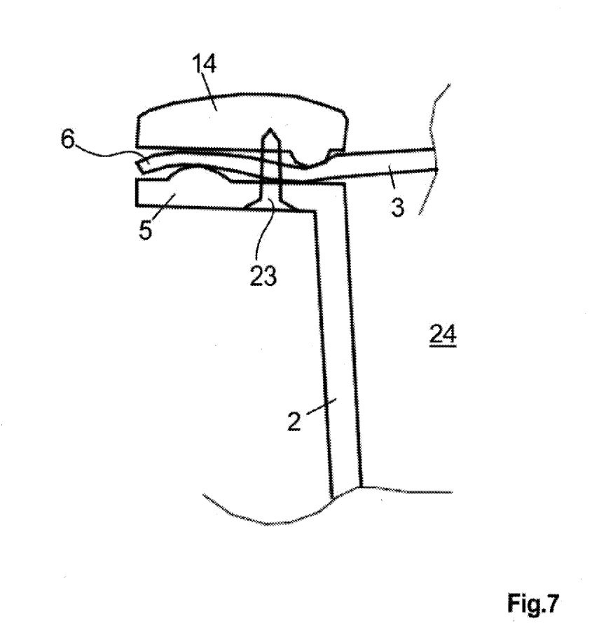

According to an alternative embodiment as shown in FIG. 7, the edge 6 of the cover film 3 is clamped between the fastening flange 5 of the housing 1 and the attachment frame 14 by means of a screw connection. For this purpose, a screw 23 is inserted perpendicular to the fastening flange 5 from a side of the fastening flange 5 facing away from the cover film 3, which penetrates the edge 6 of the cover film 3 and can be brought into screw engagement with the front attachment frame 14. The design of the fastening flange 5 and the attachment frame 14 can correspond to the embodiment shown in FIG. 4.

The cover film 3 is made of a thermoplastic material that is produced, for example, by extrusion. In a flat state, the cover film 3 is printed with color and/or an optical structure, so that, for example, an edge-side masking section is produced. In a further process step, the cover film 3 is formed by means of a thermoforming tool by applying heat and/or pressure in such a way that it has the desired three-dimensional shape. Preferably, the cover film 3 is slightly curved to follow the contour of a vehicle body cut-out.

The optional printing on the cover film 3 can, for example, be a partial color coating or have a diffuser structure or micro-optics on an inner side facing the housing 1. This diffuser structure or micro-optics can be applied to the cover film 3 using a roll-to-roll process. In a final step after printing and, if necessary, forming, the corresponding cover film 3 is cut to size or punched out. If necessary, the forming process can also include relatively sharp bends or bends with relatively small radii.

To mount the lighting device, the first step is to bring the edge of the cover film 3 into contact with the fastening flange 5 and, if necessary, the attachment frame 14. In a second step, the force-fit connection is made by attaching the clamping element 7 or the screw connection. When the clamping element 7 is applied to the corresponding contact surfaces of the fastening flange 5, the cover film 3 and, if applicable, the attachment frame 14, the opposing legs 8, 8' are moved apart against a spring force until, in the assembly position, they press the edge 6 of the cover film 3 against the fastening flange 5 of the housing 1, exerting the fixing force F.

### List of reference signs:

1 housing
2 wall
3 cover film
4 opening edge
5 fastening flange
6 edge
7 clamping element
8,8' legs
9 bulge
10 indentation
11 edge
12 edge
13 apex
14 attachment frame
15 bulge
16 bulge
17 sealing element
18 sealing element
19 indentation
20 indentation
21 sealing element
22 sealing element
23 screw
E extension direction
H main radiation direction
F latching or clamping force
w_{A} wall thickness
b_{R}, b_{F} width

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for vehicles, comprising:
a shell-shaped housing in which a number of optical components are arranged for generating at least one lighting function with at least one predetermined light distribution, wherein the housing comprises a base and a wall raised above the base, the wall having an opening edge that defines an opening in the housing; and
a cover plate that is firmly attached to the housing in a region of the opening edge, wherein the cover plate is a printable cover film that is connected by friction to the opening edge of the housing.

2. The lighting device according to claim 1, wherein the cover film is at least partially reversibly formable.

3. The lighting device according to claim 1, wherein the cover film has a wall thickness equal to or less than 1 mm.

4. The lighting device according to claim 1, wherein the cover film is connected to the housing by screwing or by clamping.

5. The lighting device according to claim 1, wherein the opening edge of the housing has a fastening flange which projects laterally from the wall of the housing and against which a circumferential edge of the cover film bears.

6. The lighting device according to claim 5, wherein the edge of the cover film is held between the fastening flange of the housing and an attachment frame in a clamping or circumferentially sealing manner.

7. The lighting device according to claim 6, wherein a width of the attachment frame and a width of the fastening flange of the housing are the same.

8. The lighting device according to claim 6, wherein the fastening flange of the housing or the attachment frame has bulges or indentations on a side facing the edge of the cover film such that the edge of the cover film is arranged deformed transversely to a plane of extension in a mounting position.

9. The lighting device according to claim 5, wherein an additional clamping element is provided by which the edge of the cover film can be clampingly connected to the fastening flange of the housing or by which the edge of the cover film arranged between the fastening flange of the housing and an attachment frame can be clampingly connected.

10. The lighting device according to claim 9, wherein the clamping element is U-shaped in cross-section and a sealing element is arranged between the edge of the cover film and the fastening flange or between the edge of the cover film and the attachment frame.

11. The lighting device according to claim 6, wherein the edge of the cover film is arranged with flat and even contact between the fastening flange of the housing and the attachment frame, the fastening flange and the attachment frame being pressed together by the clamping element, and wherein a plurality of clamping elements are arranged at a distance from one another in a circumferential direction of the housing.

12. The lighting device according to claim 6, wherein bulges or indentations of the fastening flange and of the attachment frame or sealing elements resting against the fastening flange and the attachment frame are arranged offset in a direction of extension of the edge of the cover film such that the edge of the cover film is shaped in a wave-like manner in an assembly position.

13. A method for mounting a lighting device, wherein a shell-shaped housing having a base and a wall projecting from the base and a cover plate closing an opening thereof are firmly connected to one another, the method comprising:
moving the cover plate into a mounting position while covering the opening of the housing such that an edge of the cover plate is placed flat against a fastening flange projecting laterally from the wall of the housing; and
clamping the edge of the cover film together with the fastening flange by a clamp-like clamping element or by a screw connection.

14. The method according to claim 13, wherein, in the first step, an attachment frame is additionally applied to the edge of the cover film such that the edge of the cover film is arranged between the fastening flange and the attachment frame, and wherein the fastening flange and the attachment frame have at least one indentation or bulge such that, after clamping the edge of the cover film between the fastening flange and the attachment frame, the edge of the cover film has a wavy shape.

15. A method for producing a cover film, comprising:
producing the cover film from a thermoplastic material;
printing the cover film in a flat state with a color or an optical structure; and
forming the cover film by heat or pressure such that it has a curved shape covering the opening of the housing;
wherein inherent rigidity of the cover film is sufficiently low such that the cover film is reversibly elastically deformable when subjected to a normal force not exceeding a predetermined threshold force.
